(19) United States
(12) Patent Application Publication
(10) Pub. No.: US 2006/0129389 A1
(43) Pub. Date: Jun. 15, 2006

(54) Spectrum modeling

(76) Inventors: Albertus Cornelis Den Brinker, Eindhoven (NL); Arnoldus Werner Johannes Oomen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 11/345,993

(22) Filed: Feb. 2, 2006

Related U.S. Application Data
(63) Continuation of application No. 10/031,024, filed on Mar. 28, 2002, now abandoned.

(30) Foreign Application Priority Data
May 17, 2000 (WO) EP00/04599

(51) Int. Cl. G10L 19/04

(52) U.S. Cl. 704/219

(57) ABSTRACT

Modeling a target spectrum (S) is provided by determining (21) filter parameters (pᵢ,qᵢ) of a filter which has a frequency response approximating the target spectrum (S), wherein the target spectrum is split in at least a first part and a second part, a first modeling operation is used on the first part of the target spectrum to obtain auto-regressive parameters, a second modeling operation is used on the second part of the target spectrum to obtain moving-average parameters, and the auto-regressive parameters and the moving-average parameters are combined to obtain the filter parameters. The invention is preferably applied in audio coding, wherein a spectrum of a noise component (S) in the signal (A) is modeled.

The invention relates to modeling a target spectrum by determining filter parameters of a filter which has a frequency response approximating the target spectrum.

P. Stoica and R. L. Moses, Introduction to spectral analysis, Prentice Hall, N.J., 1997, pp. 101-108, disclose parametric methods for modeling rational spectra. In general, a moving-average (MA) signal is obtained by filtering white noise with an all-zero filter. Owing to this all-zero structure, it is not possible to use an MA equation to model a spectrum with sharp peaks unless the MA order is chosen ‘sufficiently large’. This is to be contrasted to the ability of the auto-regressive (AR), or all-pole, equation to model narrow-band spectra by using fairly low model orders. The MA model provides a good approximation for those spectra which are characterized by broad peaks and sharp nulls. Such spectra are encountered less frequently in applications than narrow-band spectra, so there is somewhat limited engineering interest in using MA signal model for spectral estimation. Another reason for this limited interest is that the MA parameter estimation problem is basically a non-linear one, and is significantly more difficult to solve than the AR parameter estimation problem. In any case, the types of difficulties in MA and ARMA estimation problems are quite similar.

Spectra with both sharp peaks and deep nulls cannot be modeled by either AR or MA equations of reasonably small orders. It is in these cases where the more general ARMA model, also called pole-zero model, is valuable. However, the great initial promise of ARMA spectral estimation diminishes to some extent because there is yet no well-established algorithm from both theoretical and practical standpoints for ARMA parameter estimation. The theoretically optimal ARMA estimators' are based on iterative procedures whose global convergence is not guaranteed. The ‘practical ARMA estimators’ are computational simple and often reliable, but their statistical accuracy may be poor in some cases. The prior art discloses two stage models, in which first an AR estimation is performed and thereafter an MA estimation. Both methods give inaccurate estimates or require high computational effort in those cases where the poles and zeroes of the ARMA model description are closely spaced together at positions near the unit circle. Such ARMA models, with nearly coinciding poles and zeroes of modulus close to one, correspond to narrow-band signals. In both methods, the estimation of the zeros translates to a non-linear optimization problem.

An object of the invention is to provide less complicated ARMA spectrum modeling. To this end, the invention provides a method and a device for modeling a target spectrum, a method of encoding an audio signal, a method of decoding an encoded audio signal, an audio encoder, an audio player, an audio system, an encoded audio signal and a storage medium as defined in the independent claims. Advantageous embodiments are defined in the dependent claims.

In a first embodiment of the invention, the spectrum to be modeled is split into a first part and a second part wherein the first part is modeled by a first model to obtain auto-regressive parameters and the second part is modeled by a second model to obtain moving-average parameters. The combination of the constituent processes provides an accurate ARMA model. The splitting is preferably performed in an iterative procedure. In a method according to the invention, a non-linear optimization problem may be omitted.

The invention provides an ARMA model estimation that is suitable for a real-time implementation. The invention recognizes that AR or MA models are not always sufficiently accurate or parsimonious in conveying the information of the power spectral estimate. On a logarithmic scale, with Linear Predictive Coding (LPC) methods (all-pole modeling) peaks of the function are usually well modeled but valleys are under-estimated. The reverse occurs in an all-zero model. In audio and speech coding, which is a preferred field of application of the invention, a logarithmic scale is more appropriate than a linear scale. Therefore, a good fit to the power spectrum on a logarithmic scale is preferred. The model according to the invention gives a better trade-off between complexity and accuracy. The error in this model can be evaluated on a logarithmic scale.

In a preferred embodiment of the invention, the second modeling operation comprises the step of using the first modeling operation on a reciprocal of the second part of the target spectrum. In this embodiment, only one modeling operation needs to be defined wherein the auto-regressive parameters are obtained by modeling the first part of the spectrum and the moving-average parameters are obtained by modeling a reciprocal of the second part of the spectrum by the same, i.e. first modeling operation. Although less preferred, it is also possible to use a second modeling operation that yields moving-average parameters on the second part and, to obtain auto-regressive parameters use the same second modeling operation on a reciprocal of the first part of the spectrum.

The invention is preferably used in parametric modeling of a noise component in an audio signal. The audio signal may comprise audio in general like music, but also speech. Besides the advantages mentioned above, an ARMA model according to the invention has the further advantage that for an accurate modeling of the noise component less parameters are necessary than would be the case in full AR or MA modeling with a comparable accuracy. Less parameters means better compression.

Although the invention is preferably used in parametric modeling of a noise component in an audio signal, the invention may also be used in noise suppression schemes, in which an estimate of a noise spectrum is subtracted from a signal.

In the prior art methods according to Stoica and Moses, computational burden exists in matrix inversions. Further, it is unclear to which value the order of the AR model should be set, except that it needs to be high for zeros close to the unit circle. Therefore, the computational complexity is difficult to access. In the method according to the invention, computational burden exists in the iterative nature of the splitting process and the transformation to the frequency domain (Stoica and Moses calculate primarily in the time domain). The invention provides better results in case of zeros close to the unit circle. Furthermore, the transformation to the frequency domain opens the possibility of manipulations. An example is to make the split frequency dependent on the basis of a priori or measurement data. Another advantage is the applicability to warped frequency data, as is explained below. In order to guarantee real-time ARMA modeling, a fast transformation to the frequency domain should be applied, e.g. Welch's averaged periodogram method which is well known in the art.

Auto-regressive and moving average parameters can be represented in different ways by e.g. polynomials, zeros of the polynomials (together with a gain factor), reflection coefficients or log(Area) ratios. In an audio coding application, representation of the auto-regressive and moving average parameters is preferably in log(Area) ratios. The auto-regressive and moving average parameters that are determined in the ARMA modeling according to the invention are combined to obtain the filter parameters that are transmitted.

WO 97/28527 discloses the enhancement of speech parameters by determining a background noise PSD estimate, determining noisy speech parameters, determining a noisy speech PSD estimate from the speech parameters, subtracting a background noise PSD estimate from the noisy speech PSD estimate, and estimating enhanced speech parameters from the enhanced speech PSD estimate. The enhanced parameters may be used for filtering noisy speech in order to suppress the noise or be used directly as speech parameters in speech encoding. An estimate of the PSD is obtained by an auto-regressive model. It is noted in this document that such an estimate is not a statistically consistent one, but that in speech signal processing that is not a serious problem.

U.S. Pat. No. 5,943,429 discloses a spectral subtraction noise suppression method in a frame based digital communication system. The method is performed by a spectral subtraction function which is based on an estimate of the power spectral density of background noise of non-speech frames and an estimate of the power spectral density of speech frames. Each speech frame is approximated by a parametric model that reduces the number of degrees of freedom. The estimate of the power spectral density of each speech frame is estimated from the approximative parametric model. Also in this case, the parametric model is an AR model.

U.S. Pat. No. 4,188,667 discloses an ARMA filter and a method for obtaining the parameters for such filter. The first step of this method involves performing an inverse discrete Fourier transform of the arbitrary selected frequency spectrum of amplitude to obtain a truncated sequence of coefficients of a stable pure moving-average filter model, i.e. the parameters of a non-recursive filter model. The truncated sequence of coefficients, which has N+1 terms, is then convolved with a random sequence to obtain an output associated with the random sequence. A time-domain, convergent parameter identification is then performed, in a manner that minimizes an integral error function norm, to obtain the near minimum order auto-regressive and moving-average parameters of the model having the desired amplitude- and phase-frequency responses. The parameters are identified off-line. The object of this embodiment is to provide a minimum or near minimum stable ARMA filter. The parameters are determined in a batch filter program.

In general, estimating a power spectral density function differs from characterizing a linear system in that, inter alia, in such characterization, the input and output signals are available and used, whereas in estimating a power spectral density function, only the power spectral density function is available (not an associated input signal).

The aforementioned and other aspects of the invention will be apparent from and elucidated with reference to the embodiments described hereinafter.

In the drawings:

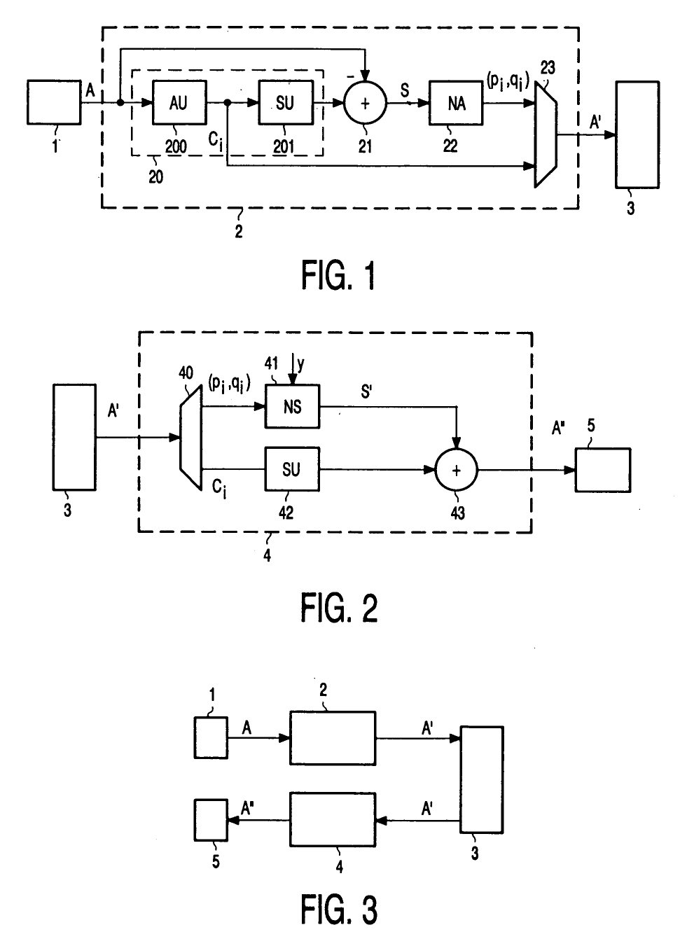

FIG. 1 shows an illustrative embodiment comprising an audio encoder according to the invention;

FIG. 2 shows an illustrative embodiment comprising an audio player according to the invention;

FIG. 3 shows an illustrative embodiment of an audio system according to the invention;

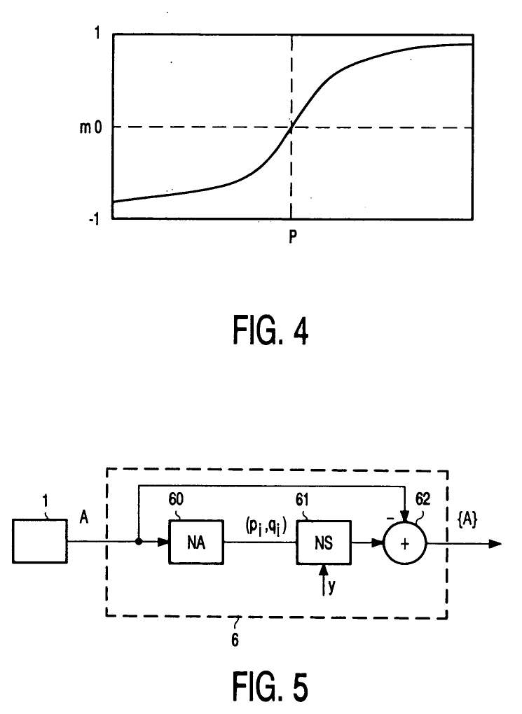

FIG. 4 shows an exemplary mapping function m; and

FIG. 5 shows an embodiment of a noise suppression device in accordance with the invention.

The drawings only show those elements that are necessary to understand the invention.

The invention is preferably applied in audio and speech coding schemes in which synthetic noise generation is employed. Typically, the audio signal is coded on a frame to frame basis. The power spectral density function (or a possibly non-uniform sampled version thereof) of the noise in a frame is estimated and a best approximation of the function from a set of squared amplitude responses of a certain class of filters is found. In one embodiment of the invention, an iterative procedure is used to estimate an ARMA model based on existing low-complexity techniques for fitting AR and MA models to the power spectral density function.

FIG. 1 shows an exemplary audio encoder 2 according to the invention. An audio signal A is obtained from an audio source 1, such as a microphone, a storage medium, a network etc. The audio signal A is input to the audio encoder 2. The audio signal A is parametrically modeled in the audio encoder 2 on a frame to frame basis. A coding unit 20 comprises an analysis unit (AU) 200 and a synthesis unit (SU) 201. The AU 200 performs an analysis of the audio signal and determines basic waveforms in the audio signal A. Further, the AU 200 produces waveform parameters or coefficients Cᵢ to represent the basic waveforms. The waveform parameters Cᵢ are furnished to the SU 201 to obtain a reconstructed audio signal, which consists of synthesized basic waveforms. This reconstructed audio signal is furnished to a subtractor 21 to be subtracted from the original audio signal A. This rest signal S is regarded as a noise component of the audio signal A. In a preferred embodiment, the coding unit 20 comprises two stages: one that performs transient modeling, and another that performs sinusoidal modeling on the audio signal after subtraction of the modeled transient components.

According to an aspect of the invention, the power spectral density function of the noise component S in the audio signal A is ARMA modeled resulting in auto-regressive parameters pᵢ and moving-average parameters qᵢ. The spectrum of the noise component S is modeled according to the invention in noise analyzer (NA) 22 to obtain filter parameters (pᵢ,qᵢ). The estimation of the parameters (pᵢ,qᵢ) is performed by determining filter parameters of a filter in NA 22 which has a transfer function H⁻¹ that makes the function S after filtering, i.e. H¹(S), spectrally as flat as possible, i.e. ‘whitening the frequency spectrum’. In a decoder, a reconstructed noise component can be generated which has approximately the same properties as the noise component S by filtering white noise with a filter with transfer function H that is opposite to the filter used in the encoder. The filtering operation of this opposite filter is determined by the ARMA parameters pᵢ and qᵢ. The filter parameters (pᵢ,qᵢ) are included together with the waveform parameters Cᵢ in an encoded audio signal A′ in a multiplexer 23. The audio stream A′ is furnished from the audio encoder to an audio player over a communication channel 3, which may be a wireless connection, a data bus or a storage medium, etc.

An embodiment comprising an audio player 4 according to the invention is shown in FIG. 2. An audio signal A′ is obtained from the communication channel 3 and de-multiplexed in de-multiplexer 40 to obtain the parameters (pᵢ,qᵢ) and the waveform parameters Cᵢ that are included in the encoded audio signal A′. The parameters (pᵢ,qᵢ) are furnished to a noise synthesizer (NS) 41. The NS 41 is mainly a filter with a transfer function H. A white noise signal y is input to the NS 41. The filtering operation of the NS 41 is determined by the ARMA parameters (pᵢ,qᵢ). By filtering the white noise y with the NS 41, that is opposite to the filter (NA) 22 used in the encoder 2, a noise component S′ is generated which has approximately the same stochastic properties as the noise component S in the original audio signal A. The noise component S′ is added in adder 43 to other reconstructed components, which are e.g. obtained from a synthesis unit (SU) 42 to obtain a reconstructed audio signal (A″). The SU 42 is similar to the SU 201. The reconstructed audio signal A″ is furnished to an output 5, which may be a loudspeaker, etc.

FIG. 3 shows an audio system according to the invention comprising an audio encoder 2 as shown in FIG. 1 and an audio player 4 as shown in FIG. 2. Such a system offers playing and recording features. The communication channel 3 may be part of the audio system, but will often be outside the audio system. In case the communication channel 3 is a storage medium, the storage medium may be fixed in the system or be a removable disc, memory stick, tape etc.

Below, the modeling of the spectrum of S is further described. Suppose S is a power spectral density function of a discrete-time real valued signal. Further, S is a real-valued function defined on the interval I=(−π,π). S is assumed to be symmetric with min (S)>0 and max (S)<∞. For convenience, it is assumed that the logarithmic mean of S equals zero, i.e.

$$\frac{1}{2 π} {\int }_{I}^{} ln S ( θ ) ⅆ θ = 0 \qquad ( 1 )$$

The extension to cases with a mean on the log scale unequal to zero is straight forward, but can be handled in various ways. Note that S can be derived from samples of an actually measured power spectral density function by suitable interpolation and normalization.

Let H be a rational transfer function according to H=B/A with A=Πᵢ₌₁^{N}(1−z⁻¹pᵢ) and B=Πᵢ₌₁^{M}(1−z⁻¹qᵢ). Here, pᵢ and qᵢ are the poles and the zeros of the transfer function H, respectively. Note, that the logarithmic mean of |H|² also equals zero.

The target function is approximated by the squared modulus of H, i.e. S≈|H|².

A measure for the correctness of the approximation is introduced by:

$$J = \frac{1}{2 π} {\int }_{I}^{} \frac{1}{2} {( ln S - ln {\vert H \vert}^{2} )}^{2} ⅆ θ \qquad ( 2 )$$

The criterion (2) can be rewritten to

$$J = \frac{1}{2 π} {\int }_{I} ln ( S / {\vert H \vert}^{2} ) + \frac{1}{2} {( ln ( S / {\vert H \vert}^{2} ) )}^{2} ⅆ θ \qquad ( 3 )$$

in view of the fact that both S and |H|² have a logarithmic mean equal to zero. If furthermore, S(θ)/|H(e^{jv}|²≈1 for each θ, the criterion (2) is approximated by J′−1, where

$${J}^{′} = \frac{1}{2 π} {\int }_{I}^{} \frac{S}{{\vert H \vert}^{2}} ⅆ θ \qquad ( 4 )$$

This means that in the neighborhood of the optimal solution, the criteria (2) and (4) are practically equal.

It is well known that in the case that H=1/A (i.e. B=1), (4) is associated with Forward Linear Prediction (FLP), which is an example of an LPC method. Therefore, the polynomial A can be found by calculating (or at least approximating) the auto-correlation function associated with S and solving the Wiener-Hopf equations. The qualitative results of such a procedure are also well known. The above sketched procedure will give good approximations to the peaks of S (when measured or visualized on a logarithmic scale) but usually provides only poor fits to the valleys of S. To conclude the above, a standard procedure is available for estimating an all-pole model from the power spectral density function, which provides an approximation to the optimal solution with (2) and which basically is good at modeling the peaks of S.

It is noted that peaks and valleys of In S have essentially the same characteristic except for a reversal of sign: a peak is a positive excursion, whereas a trough is a negative one. Consequently, taking Ŝ=1/S , an all-zero model can be estimated by using the above sketched procedure for an all-pole model. From the result of this procedure, a good fit to the valleys of S is expected, but only poor or at most fair fits to the peaks of S.

An object of the invention is to provide a good representation of S for both the peaks and the valleys. In an embodiment of the invention, an ARMA model is provided in which all-pole modeling and all-zero modeling are combined in the following way. S is split in two parts as S=S_{A}/S_{B}. From S_{A} an all pole model is estimated yielding the polynomial A and from S_{B} an all-zero model is estimated yielding the polynomial B. The combination |H|²=|B|²/|A|² is considered an approximation of S.

According to a preferred aspect of the invention the split of S is performed in an iterative process. The iteration step is called l. At each step of the iteration, a new split S_{A,l} and S_{B,l} is generated and the corresponding estimates Aₗ and Bₗ are calculated. A given subdivision of S in S_{A} and S_{B} is used to start with and thereafter parts of S_{B} that are not modeled accurately are attributed to S_{A} and vice versa. At step l-1 in the iterative scheme, Hₗ₋₁=Bₗ₋₁/Aₗ₋₁. Hereafter, the partial functions S_{A,l}=S/|Bₗ₋₁|² and S_{B,i}=1/S|Aₗ₋₁|² are considered. In this way, from S those parts that can be modeled accurately by the all-pole model are excluded from contributing to S_{B}. Similarly, those parts of S that could be modeled by an all-zero filter are excluded from S_{A}. From S_{A,l} and S_{B,l} the functions Aₗ and Bₗ are estimated. In this way, parts which in the previous iteration could not be modeled appropriately are swapped.

For a next step, preferably, the following four possible combinations are considered:
G₀=Bₗ₋₁/Aₗ₋₁ G₁=Bₗ₋₁/Aₗ
G₂=Bₗ/Aₗ₋₁ G₃=Bₗ/Aₗ
The best fit to S of these four candidate filters is defined as the one with minimum error; the associated filter is the final result of step 1. Preferably, Hₗ (and thus Aₗ and Bₗ) is selected as the best of the candidates Gᵢ with i=0,1,2,3 on a logarithmic criterion according to

$${H}_{l} = arg {min}_{{G}_{i}} \frac{1}{2 π} {\int }_{I}^{} {( ln S - ln {\vert {G}_{i} \vert}^{2} )}^{2} ⅆ θ \qquad ( 5 )$$

From here, the procedure is proceeded with step l+1, by taking S_{A,l+1}=S/|Bₗ|² and S_{B,l+1}=1/S|Aₗ|².

Any common stop procedure can be used, e.g. a maximum number of iterations, a sufficient accuracy of the current estimate, or insufficient progress in going from one step to another.

A slightly different procedure performs the AR and MA modeling alternately. If the previous step returned a refined estimate of the numerator Bₗ₋₁, then
S_{A,l}=S/|Bₗ₋₁|²
and calculate Aₗ. Bₗ is taken as Bₗ₋₁.
If the previous step returned a refined estimate of the numerator Aₗ₋₁, then
S_{B,l}=1/S|Aₗ₋₁|²
and calculate Bₗ. Aₗ is taken as Aₗ₋₁.
From Aₗ and Bₗ, Hₗ is constructed and the error evaluated (e.g. a mean squared difference on a log scale)

There are many alternatives to initialize the iterative scheme. Without limitation, the following possibilities are mentioned:

First, a simple way of initializing is provided by taking S_{A,0}=S and S_{B,0}=1 and S_{A,0}=1 and 1/S_{B,0}=S. Next, A₀ and B₀ are calculated. From these two initial estimates, a best fit (according to some criterion) is chosen. In this way, the first guess is either an all-pole or an all-zero model.

Second, S may be split in equal parts according to S_{A,0}=1/S_{B,0}=\sqrt{S}.

Third, since S_{A} should contain the peaks and S_{B} the valleys, a favorable split is to attribute everything above a mean logarithmic level (e.g. above zero) to S_{A,0} and anything below said level to S_{B,0}. This division may be made at the global logarithmic mean, but also at some local logarithmic mean.

Fourth, a further splitting process takes into account that in power spectral density functions on a logarithmic scale, poles and zeros close to the unit circle give rise to pronounced peaks and valleys, respectively. The data S is split on the notion that peaks and valleys in logs are more appropriately handled by the all-pole and all-zero model, respectively. Define:
P=log S
P_{A}=log S_{A}
P_{B}=log S_{B}
Consider the mapping function m with m: [symbol] →[−1,1]. The mapping function will typically be a non-decreasing, point-symmetric sigmoidal function in view of the symmetry of pole and zero behavior on a log scale. However, non-symmetric functions can be used as well and have the effect of giving more weight to either the pole or the zero modeling. An exemplary mapping function m is shown in FIG. 4.
Consider the following initial split:

$${P}_{A} = \frac{1 + m ( P )}{2} P$$

$${P}_{B} = - \frac{1 - m ( P )}{2} P$$

In this way, positive excursion (peaks) of P are pre-dominantly attributed to P_{A} and, consequently, modeled by the all-pole filter. Negative excursions (valleys) of P are mostly attributed to P_{B} and, consequently, modeled by the all-zero filter. From P_{A} and P_{B}, S_{A} and S_{B} are constructed and, next A₀ and B₀ are calculated.
There are two limiting cases of m (which are similar to the second and the third initialization as discussed above):
m=0, then S_{A,0}=1/S_{B,0}=\sqrt{S}
m is a signum function:

$$m ( x ) = \{ \begin{matrix}- 1 , x < 0 \\ 0 , x = 0 \\ 1 , x > 0\end{matrix}$$

In this case:

$${S}_{A} ( x ) = \{ \begin{matrix}S ( x ) , S ( x ) > 1 \\ 1 , S ( x ) \leq 1\end{matrix} \\ 1 / {S}_{B} ( x ) = \{ \begin{matrix}S ( x ) , S ( x ) < 1 \\ 1 , S ( x ) \geq 1\end{matrix}$$

The proposed spectrum modeling is very apt at modeling peaks and valleys since, basically, these constitute the patterns generated by the degrees of freedom offered by the poles and zeros. Consequently, the procedure is sensitive to outliers: rather than smoothing, these will appear in the approximation. Therefore, the input data S has to be an accurate estimate (in the sense of a small ratio of standard deviation and mean per frequency sample) or S must be pre-processed (e.g. smoothed) in order to suppress undesired modeling of outliers. This observation holds especially if the number of degrees of freedom in the model is relatively large with respect to the number of data points on which the power spectral density function is based.

Convergence can not be established without knowledge of the actual optimization steps A and B and the selection criterion. It is not guaranteed that the error reduces at every step in the iteration process.

In many cases, it is desired to have a good approximation of the power spectral density function on a logarithmic scaled frequency axis. For example, it is common practice to evaluate the result of a fit on a spectrum visually in the form of a Bode plot. Similarly, for audio and speech applications, the preferred scale would be a Bark or Equivalent Rectangular Bandwidth (ERB) scale which is more or less a logarithmic scale. The method according to the invention is suitable for frequency-warped modeling. The spectral density measurements can be calculated on any frequency grid whatsoever. Under the condition that the frequency warping is close to that of a first-order all-pass section, this can be re-wrapped while maintaining the order of the ARMA model.

Application areas of the invention include audio coding, buried data techniques, noise shaping and fast filter design. A further exemplary embodiment of the invention is shown in FIG. 5. In FIG. 5 an audio signal A is obtained from a source 1 in a similar way as in FIG. 1. The audio signal A is processed in a noise-suppression device 6. The noise-suppression device comprises a noise analyzer (NA) 60 and a noise synthesizer (NS) 61. In this embodiment, the NA 60 directly analyzes noise in the audio signal. A spectrum of the noise is modeled by determining ARMA parameters (pᵢ,qᵢ) according to the invention. The NS 61, which is mainly a filter, has a frequency response approximating the spectrum of the noise. The NS 61 generates reconstructed noise by filtering a white noise y, wherein the filtering properties of NS 61 are determined by the ARMA parameters (pᵢ,qᵢ). In an adder 61, the reconstructed noise is subtracted from the audio signal (A) to obtain a noise-filtered audio signal ({A}′). Preferably, the noise spectrum is modeled in one or more (previous) frames that, besides noise, do not contain much signal, e.g. speech-free frames in speech coding. The reconstructed noise can be subtracted in frames that do contain more signal, e.g. speech frames in speech coding.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, modeling a target spectrum is provided by determining filter parameters of a filter which has a frequency response approximating the target spectrum, wherein the target spectrum is split in at least a first part and a second part, a first modeling operation is used on the first part of the target spectrum to obtain auto-regressive parameters, a second modeling operation is used on the second part of the target spectrum to obtain moving-average parameters, and the auto-regressive parameters and the moving-average parameters are combined to obtain the filter parameters. The invention is preferably applied in audio coding, wherein a spectrum of a noise component in the signal is modeled.

A model for fast ARMA estimation from power spectral density data has been explained. It uses e.g. FLP techniques for the estimation of the numerator and the denominator polynomials and an iterative procedure to produce the most appropriate split in the power spectral density data to attribute parts of the data to the all-pole model and other parts to the all-zero model.

1. A method of modeling (2,22) a target spectrum (S) by determining filter parameters (pᵢ,qᵢ) of a filter (41) which has a frequency response (S′) approximating the target spectrum (S),
characterized in that the method comprises the steps of:
splitting (22) the target spectrum in at least a first part and a second part;
using (22) a first modeling operation on the first part of the target spectrum (S) to obtain auto-regressive parameters (pᵢ);
using (22) a second modeling operation on the second part of the target spectrum to obtain moving-average parameters (qᵢ); and
combining (22) the auto-regressive parameters (pᵢ) and the moving-average parameters (qᵢ) to obtain the filter parameters (pᵢ,qᵢ).

2. A method as claimed in claim 1, wherein the second modeling operation (22) comprises the step of:
using the first modeling operation on a reciprocal of the second part of the target spectrum.

3. A method as claimed in claim 1, wherein the step of splitting (21) comprises:
taking an initial split in an initial first part and an initial second part; and
using an iterative procedure to obtain a better split than the initial split until some stop criterion is met.

4. A method as claimed in claim 3, wherein the iterative procedure comprises:
using a first modeling operation on a first part of a previous split to obtain new auto-regressive parameters;
using a second modeling operation on a second part of a previous split to obtain new moving-average parameters; and
re-attributing parts of the first part of the previous split that could not be modeled accurately by the first modeling operation to the second part of the previous split, and parts of the second part of the previous split that could not be modeled accurately by the second modeling operation to the first part of the previous split to obtain a new split.

5. A method as claimed in claim 4, wherein the step of re-attributing comprises:
dividing the first part of the previous split by an estimate of the target spectrum based on moving-average parameters; and
dividing the second part of the previous split by an estimate of the target spectrum based on auto-regressive parameters.

6. A method as claimed in claim 2, wherein the initial first part comprises at least a significant part of the target spectrum above a mean logarithmic level and the initial second part comprises at least a significant part below said level.

7. A method as claimed in claim 2, wherein the initial split is determined by:
$${P}_{A} = \frac{1 + m ( P )}{2} P$$
$${P}_{B} = - \frac{1 - m ( P )}{2} P$$
where:
P=log(the target spectrum)
P_{A}=log(the first part of the target spectrum)
P_{B}=log(the second part of the target spectrum)
and m is a mapping function with m: [symbol] →[−1,1].

8. A device (2), comprising:
means (22) for determining filter parameters (pᵢ,qᵢ) of a filter (41) which has a frequency response (S′) approximating a target spectrum,
characterized in that the device further comprises:
means (22) for splitting the target spectrum (S) in at least a first part and a second part;
means (22) for using a first modeling operation on the first part of the target spectrum (S) to obtain auto-regressive parameters (pᵢ);
means (22) for using a second modeling operation on the second part of the target spectrum (S) to obtain moving-average parameters (qᵢ); and
means (22) for combining the auto-regressive parameters (pᵢ) and the moving-average parameters (qᵢ) to obtain the filter parameters (pᵢ,qᵢ).

9. A method of suppressing noise (6) in an audio signal (A), the method comprising:
modeling (60) a spectrum of the noise by determining filter parameters (pᵢ,qᵢ) of a filter (61) which has a frequency response approximating the spectrum of the noise; obtaining (61) reconstructed noise by filtering (61) a white noise (y) with a filter (61), which properties are determined by the filter parameters (pᵢ,qᵢ); and
subtracting (62) the reconstructed noise from the audio signal (A) to obtain a noise-filtered audio signal ({A});
the step of modeling (60) comprising:
splitting (60) the spectrum in at least a first part and a second part;
using (60) a first modeling operation on the first part of the spectrum to obtain auto-regressive parameters (pᵢ);
using (60) a second modeling operation on the second part of the noise spectrum to obtain moving-average parameters (qᵢ); and
combining (60) the auto-regressive parameters (pᵢ) and the moving-average parameters (qᵢ) to obtain the filter parameters (pᵢ,qᵢ);

10. A device (6) for suppressing noise in an audio signal (A), the device comprising:
means (60) for modeling a spectrum of the noise by determining filter parameters (pᵢ,qᵢ) of a filter (61) which has a frequency response approximating the spectrum of the noise;
means (61) for obtaining reconstructed noise by filtering (61) a white noise (y) with a filter (61), which properties are determined by the filter parameters (pᵢ,qᵢ); and
means (62) for subtracting the reconstructed noise from the audio signal (A) to obtain a noise-filtered audio signal ({A});
the means for modeling (60) comprising:
means (60) for splitting the spectrum in at least a first part and a second part;
means (60) for using a first modeling operation on the first part of the spectrum to obtain auto-regressive parameters (pᵢ);
means (60) for using a second modeling operation on the second part of the noise spectrum to obtain moving-average parameters (qᵢ); and
means (60) for combining the auto-regressive parameters (pᵢ) and the moving-average parameters (qᵢ) to obtain the filter parameters (pᵢ,qᵢ);

11. A method of encoding (2,21) an audio signal (A), comprising the steps of:
determining (200) basic waveforms in the audio signal (A);
obtaining (21) a noise component (S) from the audio signal (A) by subtracting the basic waveforms from the audio signal (A);
modeling (22) a spectrum of the noise component (S) by determining filter parameters (pᵢ,qᵢ) of a filter (41) which has a frequency response (S′) approximating the spectrum of the noise component (S); and
including (23) the filter parameters (pᵢ,qᵢ) and waveform parameters (Cᵢ) representing the basic waveforms in an encoded audio signal (A′);
the step of modeling comprising:
splitting (22) the spectrum (S) in at least a first part and a second part;
using (22) a first modeling operation on the first part of the spectrum (S) to obtain auto-regressive parameters (pᵢ);
using (22) a second modeling operation on the second part of the noise spectrum (S) to obtain moving-average parameters (qᵢ); and
combining (22) the auto-regressive parameters (pᵢ) and the moving-average parameters (qᵢ) to obtain the filter parameters (pᵢ,qᵢ).

12. A method of decoding (4) an encoded audio signal (A′), comprising the steps of:
receiving (40) an encoded audio signal (A′) comprising waveform parameters (Cᵢ) representing basic waveforms and filter parameters (pᵢ,qᵢ), the filter parameters (pᵢ,qᵢ) being a combination of auto-regressive parameters (pᵢ) and moving-average parameters (qᵢ) as acquired in accordance with the method of claim 11;
filtering (41) a white noise signal (y) to obtain a reconstructed noise component (S′), which filtering is determined by the filter parameters (pᵢ,qᵢ);
synthesizing (42) basic waveforms based on the waveform parameters (Cᵢ); and
adding (43) the reconstructed noise component (S′) to the synthesized basic waveforms to obtain a decoded audio signal (A″).

13. An audio encoder (2) comprising:
means (200) for determining basic waveforms in the audio signal (A);
means (21) for obtaining a noise component (S) from the audio signal (A) by subtracting (21) the basic waveforms from the audio signal (A);
means (22) for modeling a spectrum of the noise component (S) by determining filter parameters (pᵢ,qᵢ) of a filter (41) which has a frequency response (S′) approximating the spectrum of the noise component (S); and
means (23) for including the filter parameters (pᵢ,qᵢ) and waveform parameters (Cᵢ) representing the basic waveforms in an encoded audio signal (A′);
the means (22) for modeling comprising:
means (22) for splitting the spectrum (S) in at least a first part and a second part;
means (22) for using a first modeling operation on the first part of the spectrum (S) to obtain auto-regressive parameters (pᵢ);
means (22) for using a second modeling operation on the second part of the noise spectrum (S) to obtain moving-average parameters (qᵢ); and
means (22) for combining the auto-regressive parameters (pᵢ) and the moving-average parameters (qᵢ) to obtain the filter parameters (pᵢ,qᵢ).

14. An audio player (4) comprising:
means (40) for receiving an encoded audio signal (A′) comprising waveform parameters (Cᵢ) representing basic waveforms and filter parameters (pᵢ,qᵢ), the filter parameters (pᵢ,qᵢ) being a combination of auto-regressive parameters (pᵢ) and moving-average parameters (qᵢ) as acquired in accordance with the method of claim 11;
means (41) for filtering a white noise signal (y) to obtain a reconstructed noise component (S′), which filtering is determined by the filter parameters (pᵢ,qᵢ);
means (42) for synthesizing basic waveforms based on the waveform parameters (Cᵢ); and
means (43) for adding the reconstructed noise component (S′) to the synthesized basic waveforms to obtain a decoded audio signal (A″).

15. An audio system comprising an audio encoder (2) as claimed in claim 13.

16. An encoded audio signal (A′) comprising:
waveform parameters (Cᵢ) representing basic waveforms; and
a spectrum of a noise component (S) represented by a combination of auto-regressive parameters (pᵢ) and moving-average parameters (qᵢ) as acquired in accordance with the method of claim 11.

17. A storage medium (3) on which an encoded audio signal (A′) as claimed in claim 16 is stored.

18. An audio system comprising an audio player (4) as claimed in claim 14.
